(19) United States
(12) Patent Application Publication
(10) Pub. No.: US 2026/0072919 A1
(43) Pub. Date: Mar. 12, 2026

(54) ELECTRONIC DEVICE AND METHOD FOR PROVIDING RECOMMENDATION SETTINGS

(71) Applicant: Samsung Electronics Co., Ltd., Suwon-si (KR)

(72) Inventors: Hyunwoo CHUN, Suwon-si (KR); Seongmin JOE, Suwon-si (KR); Arang JEONG, Suwon-si (KR); Yongdeok KIM, Suwon-si (KR); Sehyun BAE, Suwon-si (KR); Seokho YOUN, Suwon-si (KR); Heeran LEE, Suwon-si (KR); Namsu HA, Suwon-si (KR)

(21) Appl. No.: 19/295,307

(22) Filed: Aug. 8, 2025

Related U.S. Application Data
(63) Continuation of application No. PCT/KR2025/010102, filed on Jul. 10, 2025.

(30) Foreign Application Priority Data
Sep. 12, 2024 (KR) 10-2024-0125002

(51) Int. Cl. G06F 16/2457

(52) U.S. Cl. CPC G06F 16/24578; G06F 16/24575

(57) ABSTRACT

A method performed by an electronic device, of providing recommendation settings may include: obtaining a first usage pattern based on a usage score obtained from behavioral data over a first time period, corresponding to an interaction of a user with the electronic device, obtaining a second usage pattern, based on behavioral data over a second time period longer than the first time period, corresponding to an interaction of the user with the electronic device, and stored usage pattern data, and controlling outputting of recommendation settings based on a time point of dissatisfaction with use of the electronic device, identified based on the first usage pattern and the second usage pattern.

### CROSS-REFERENCE TO RELATED APPLICATIONS

This application is a continuation of International Application No. PCT/KR2025/010102 designating the United States, filed on Jul. 10, 2025, in the Korean Intellectual Property Receiving Office and claiming priority to Korean Patent Application No. 10-2024-0125002, filed on Sep. 12, 2024, in the Korean Intellectual Property Office, the disclosures of each of which are incorporated by reference herein in their entireties.

### BACKGROUND

### Field

The disclosure relates to a method, an electronic device, and a server for providing a user with recommendation settings suitable for a situation of the electronic device.

### Description of Related Art

Electronic devices provide users with a variety of content via various applications and sources. In addition, users may use various settings items for adjusting settings of an electronic device or performing functions. As users consume various content, they want optimal settings that fit their personal viewing environment. In particular, screen brightness, screen mode, sound, etc. are factors that greatly affect the quality of the content viewing experience.

An existing configuration method is a manual method where users feel dissatisfied and manually adjust the settings. In the existing configuration method, users have difficulties in finding optimal settings by trying different combinations of settings, wasting time and experiencing the inconvenience of having to manually adjust multiple settings.

### SUMMARY

According to an example embodiment of the disclosure, a method, performed by an electronic device, of providing recommendation settings may be provided. The method may include: obtaining a first usage pattern based on a usage score obtained from behavioral data over a first time period, corresponding to an interaction of a user with the electronic device; obtaining a second usage pattern, based on behavioral data over a second time period longer than the first time period, corresponding to an interaction of the user with the electronic device, and stored usage pattern data; and controlling outputting of recommendation settings based on a time point of dissatisfaction with use of the electronic device, identified based on the first usage pattern and the second usage pattern.

According to an example embodiment of the disclosure, an electronic device for providing recommendation settings may be provided. The electronic device may include: a communication interface comprising communication circuitry, at least one processor, comprising processing circuitry, and a memory storing instructions. At least one processor, individually and/or collectively, may be configured to execute the instructions and to cause the electronic device to: obtain a first usage pattern based on a usage score obtained from behavioral data over a first time period, corresponding to an interaction of a user with the electronic device; obtain a second usage pattern, based on behavioral data over a second time period longer than the first time period, corresponding to an interaction of the user with the electronic device, and stored usage pattern data; and control outputting of recommendation settings based on a time point of dissatisfaction with use of the electronic device, which is identified based on the first usage pattern and the second usage pattern.

According to an example embodiment of the disclosure, there may be provided a non-transitory computer-readable recording medium having recorded thereon a program for executing any one of the methods, performed by an electronic device and/or a server, of generating and providing recommendation settings, as described above and below.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example operation in which an electronic device provides recommendation settings, according to various embodiments;

FIG. 2 is a flowchart illustrating an example operation in which an electronic device provides recommendation settings, according to various embodiments;

FIG. 3 is a diagram illustrating an example process by which an electronic device provides recommendation settings, according to various embodiments;

FIG. 4A is a diagram illustrating an example operation in which an electronic device collects behavioral data, according to various embodiments

FIG. 4B is a diagram illustrating an example operation in which an electronic device analyzes a usage pattern, according to various embodiments;

FIG. 4C is a diagram illustrating an example operation in which an electronic device analyzes a usage pattern, according to various embodiments;

FIG. 4D is a diagram illustrating an example operation in which an electronic device analyzes a usage pattern, according to various embodiments;

FIG. 5A is a diagram illustrating an example operation in which an electronic device generates a content group, according to various embodiments;

FIG. 5B is a diagram illustrating an example operation in which an electronic device determines settings corresponding to a content group, according to various embodiments;

FIG. 6 is a diagram illustrating an example operation in which an electronic device analyzes a situation and matches optimal settings, according to various embodiments;

FIG. 7 is a diagram illustrating an example operation in which an electronic device improves settings recommendations using feedback, according to various embodiments;

FIG. 8A is a diagram illustrating an example in which an electronic device provides recommendation settings, according to various embodiments;

FIG. 8B is a diagram illustrating an example in which an electronic device provides recommendation settings, according to various embodiments;

FIG. 9 is a block diagram illustrating an example configuration of an electronic device according to various embodiments;

FIG. 10 is a block diagram illustrating an example configuration of an electronic device according to various embodiments; and

FIG. 11 is a block diagram illustrating an example configuration of a server according to various embodiments.

### DETAILED DESCRIPTION

Terms used in the present disclosure will now be briefly described and then the disclosure will be described in greater detail. Throughout the disclosure, the expression “at least one of a, b or c” indicates only a, only b, only c, both a and b, both a and c, both b and c, all of a, b, and c, or variations thereof.

The terms used in the disclosure may be general terms currently widely used in the art by taking into account functions described herein, but may vary according to an intention of skilled persons in the related art, precedent cases, advent of new technologies, etc. Furthermore, specific terms may be arbitrarily selected, and in this case, the meaning of the selected terms will be described in detail in the relevant description. Thus, the terms used herein should be defined not by simple appellations thereof but based on the meaning of the terms together with the overall description of the disclosure.

Singular expressions used herein are intended to include plural expressions as well unless the context clearly indicates otherwise. All the terms used herein, which include technical or scientific terms, may have the same meaning that is generally understood by one of ordinary skill in the art. Furthermore, although the terms including an ordinal number such as “first”, “second”, etc. may be used herein to describe various elements or components, these elements or components should not be limited by the terms. The terms are only used to distinguish one element or component from another element or component.

Throughout the disclosure, when a part “includes” or “comprises” an element, unless there is a particular description contrary thereto, it is understood that the part may further include other elements, not excluding the other elements. In addition, terms such as “unit”, “module”, etc., described herein refer to a unit for processing at least one function or operation and may be implemented as hardware or software, or a combination of hardware and software.

Various example embodiments of the disclosure will be described more fully hereinafter with reference to the accompanying drawings. However, the disclosure may be implemented in many different forms and should not be construed as being limited to an embodiment of the disclosure set forth herein. Furthermore, parts not related to the descriptions may be omitted to more clearly illustrate the disclosure in the drawings, and like reference numerals denote like elements throughout.

Hereinafter, the disclosure is described in greater detail with reference to the accompanying drawings.

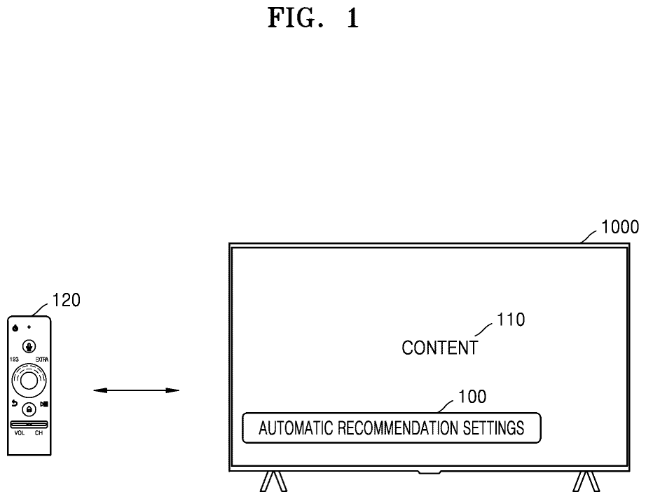

FIG. 1 is a diagram illustrating an example operation in which an electronic device provides recommendation settings, according to various embodiments.

In an embodiment of the disclosure, an electronic device 1000 may include a display, or include various types of devices that are connectable to the display. For example, and without limitation, the electronic device 1000 may include a television (TV), a smart monitor, a tablet personal computer (PC), a laptop PC, a digital signage, a large display, a 360-degree projector, a smartphone, etc., which include a display. The electronic device 1000 may include, but is not limited to, a set-top box, a desktop PC, etc., which are connectable to the display.

Referring to FIG. 1, the electronic device 1000 may provide automatic recommendation settings 100 to a user. The automatic recommendation settings 100 may be settings optimized for content 110 being played on the electronic device 1000. For example, the automatic recommendation settings 100 may include changes made to various settings items, such as screen brightness, screen mode, sound volume, and audio mode, so that they are set to be appropriate for the content 110.

In an embodiment of the disclosure, the automatic recommendation settings 100 provided by the electronic device 1000 is proactively suggested before the user explicitly expresses dissatisfaction. The electronic device 1000 may determine, based on data obtainable from the electronic device 1000, the user's dissatisfaction state while the content 110 is being played. The electronic device 1000 may provide the automatic recommendation settings 100 including optimal settings for improving the user's dissatisfaction state.

The electronic device 1000 may obtain and analyze the user's usage pattern and determine the user's dissatisfaction state based on a result of the analyzing of the usage pattern.

The electronic device 1000 may obtain behavioral data of the user manipulating the electronic device 1000 based on a user input via an input device, such as a remote control 120. In addition to the input via the remote control 120, the user input may be of various types (e.g., voice input, touch input, etc.).

The electronic device 1000 may analyze the usage pattern obtained based on the behavioral data. For example, the electronic device 1000 may analyze a first usage pattern and a second usage pattern using different analysis methods. The analysis of the first usage pattern may be a short-term usage pattern analysis based on an outlier detection method. The analysis of the first usage pattern may be a long-term usage pattern analysis based on a trend analysis method. The electronic device 1000 may predict the user's dissatisfaction state, based on the first usage pattern, the second usage pattern, and results of the analysis thereof.

When the user's dissatisfaction state is identified, the electronic device 1000 may analyze a situation of the electronic device 1000 to provide optimal settings suitable for the content 110 currently being played. For example, situation analysis may include, but is not limited to, analyzing a context of use of the electronic device 1000 and analyzing the content 110. The electronic device 1000 may obtain a result of the situation analysis as status information of the electronic device 1000. Based on the result of the situation analysis, the electronic device 1000 may identify a content group corresponding to the content 110 being played, and determine representative settings defined for the identified content group as being settings items in the automatic recommendation settings 100.

The electronic device 1000 may utilize artificial intelligence (AI) models in some of the processes for providing the automatic recommendation settings 100. For example, the electronic device 1000 may use a usage pattern analysis model, a dissatisfaction detection model, etc. Further descriptions of each model are provided below.

The electronic device 1000 may operate an AI model on-device. The electronic device 1000 may operate using a cloud-based AI approach in which the electronic device 1000 does not operate an AI model on-device but receives an output result from an AI model running on a server. For example, a usage pattern analysis model, a dissatisfaction detection model, etc. of the disclosure may be run on the server. The electronic device 1000 may transmit input data for the AI model to the server, and the server may transmit output data from the AI model to the electronic device 1000.

The automatic recommendation settings 100 may be provided in various forms. For example, the electronic device 1000 may cause the automatic recommendation settings 100 to be applied through visual or auditory output, or cause specific recommendation settings items and settings values thereof in the automatic recommendation settings 100 to be directly displayed on a screen. The electronic device 1000 may automatically apply the automatic recommendation settings 100 and output a visual or auditory notification indicating a result of the application.

Specific operations in which the electronic device 1000 provides the automatic recommendation settings 100 to the user are described in greater detail below with reference to the following drawings and descriptions thereof.

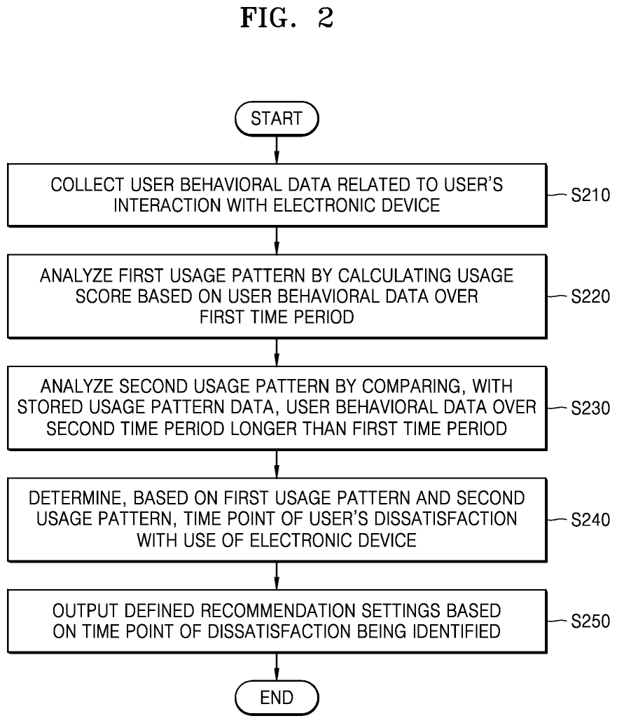

FIG. 2 is a flowchart illustrating an example operation in which an electronic device provides recommendation settings, according to various embodiments.

In operation S210, the electronic device 1000 may collect behavioral data related to a user's interaction with the electronic device 1000.

In an embodiment of the disclosure, the electronic device 1000 may collect various types of data that are recorded as the user interacts with the electronic device 1000 through user manipulation. For example, the electronic device 1000 may collect, as behavioral data, data related to various user manipulations such as the user attempting to change settings of the electronic device 1000 using a remote control, navigating through a menu, or selecting a menu. For example, examples of behavioral data may include, but are not limited to, remote control behavioral data, which includes a record of the user manipulating the electronic device 1000 using the remote control, and menu interaction data, which includes a record of the user navigating through, staying in, or making selections from a settings menu.

The electronic device 1000 may collect and store behavioral data by time interval. The collected behavioral data may be used to analyze the user's usage pattern for the electronic device 1000.

In operation S220, the electronic device 1000 may analyze a first usage pattern by calculating a usage score based on behavioral data during a first time period. The first usage pattern may be time series data indicating the usage frequency of a functionality of the electronic device 1000 over time. A result of the analysis of the first usage pattern may be used as source data for determining a time point of the user's dissatisfaction with the electronic device 1000.

In an embodiment of the disclosure, to analyze the first usage pattern, the electronic device 1000 may retrieve the behavioral data over the first time period. The first usage pattern representing a usage pattern over the first time period may refer to a short-term usage pattern.

The first time period may be a period of time defined to determine, based on an outlier detection method, a time point of the user's dissatisfaction with the use of the electronic device 1000. The first time period may be defined as a relatively short period of time compared to a second time period. For example, the first time period may be N minutes and the second time period may be M minutes, where N may be a real number less than M.

The electronic device 1000 may calculate a usage score based on the usage frequency of features included in the behavioral data over the first time period. The electronic device 1000 may identify whether the calculated usage score corresponds to an outlier. For example, when there are features with an unusually high frequency of usage over the first time period, the calculated usage score may indicate an outlier. For example, this may indicate that the first usage pattern is an abnormal usage pattern. When the usage score indicates an outlier, may refer, for example, to an increased likelihood that the user is in a state of being dissatisfied with the use of the electronic device 1000. However, when the usage score indicates an outlier, it does not necessarily refer to the user being dissatisfied with the use of the electronic device 1000.

In an embodiment of the disclosure, the electronic device 1000 may analyze the first usage pattern in real time. The electronic device 1000 may analyze the first usage pattern in real time based on behavioral data from a current time point to a time point at the first time period prior to the current time point.

In operation S230, the electronic device 1000 may analyze a second usage pattern by comparing, with stored usage pattern data, behavioral data over a second time period longer than the first time period. The second usage pattern may be time series data indicating the usage rate of a functionality of the electronic device 1000 over time. A result of the analysis of the second usage pattern may be used as source data for determining a time point of the user's dissatisfaction with the electronic device 1000.

In an embodiment of the disclosure, to analyze the second usage pattern, the electronic device 1000 may retrieve the behavioral data over the second time period. The second usage pattern representing a usage pattern over the second time period may refer to a long-term usage pattern.

The second time period may be a period of time defined to determine, based on a trend detection method, a time point of the user's dissatisfaction with the use of the electronic device 1000. Trend analysis may refer to analyzing whether a trend in usage of the electronic device 1000 corresponds to an outlier.

The electronic device 1000 may generate the second usage pattern representing a usage rate of the electronic device 1000 by time interval based on features included in the behavioral data over the second time period.

In an embodiment of the disclosure, the electronic device 1000 may identify whether the second usage pattern represents an abnormal usage pattern by comparing the second usage pattern with the stored usage pattern data. In an embodiment of the disclosure, the electronic device 1000 may detect an abnormal usage pattern using a usage pattern analysis model. The second usage pattern may be used as input data to the usage pattern analysis model. The usage pattern analysis model may be a model that is trained to infer whether a usage pattern is normal or abnormal based on a training dataset including the stored usage pattern data. The usage pattern analysis model may be implemented through various neural network architectures or modifications to the various neural network architectures. For example, the usage pattern analysis model may be implemented through, but is not limited to, a recurrent neural network (RNN) or a long short-term memory (LSTM) capable of processing time-series data. In an embodiment of the disclosure, the usage pattern analysis model may also output an outlier score indicating the degree of abnormality in a usage pattern.

For example, when the usage rate of the electronic device 1000 changes abnormally over the second time period, it may indicate that the second usage pattern is an abnormal usage pattern. When the second usage pattern shows an abnormal usage pattern, it indicates an increased likelihood that the user is dissatisfied with the use of the electronic device 1000. However, when the second usage pattern shows an abnormal usage pattern, it does not necessarily refer to the user being dissatisfied therewith.

In an embodiment of the disclosure, the electronic device 1000 may analyze the second usage pattern in real time. The electronic device 1000 may analyze the second usage pattern in real time based on behavioral data from a current time point to a time point at the second time period prior to the current time point.

In operation S240, the electronic device 1000 may determine, based on the first usage pattern and the second usage pattern, a time point of the user's dissatisfaction with the use of the electronic device 1000.

In an embodiment of the disclosure, the electronic device 1000 may determine a time point of dissatisfaction using a dissatisfaction detection model. The dissatisfaction detection model may be a model that takes, as input, at least one of the first usage pattern (time series data), a result of analysis of the first usage pattern (e.g., whether the first usage pattern is an abnormal usage pattern, an outlier score of the first usage pattern, etc.) the second usage pattern (time series data), or a result of analysis of the second usage pattern (e.g., whether the second usage pattern is an abnormal usage pattern, an outlier score of the second usage pattern, etc.), and performs a binary classification task for inferring whether the user is satisfied or dissatisfied. The dissatisfaction detection model may be implemented through various neural network architectures or modifications to the various neural network architectures, which are capable of performing a binary classification task. For example, the dissatisfaction detection model may be implemented using a combination of an RNN or LSTM suitable for processing time series data, and one or more multilayer perceptrons (MLPs), but is not limited thereto.

In an embodiment of the disclosure, the electronic device 1000 may determine a time point of dissatisfaction based on a weighted combination of the result of analysis of the first usage pattern and the result of analysis of the second usage pattern. For example, the electronic device 1000 may determine a time point of the user's dissatisfaction with the use of the electronic device 1000, based on whether a weighted combination of the outlier score of the first usage pattern and the outlier score of the second usage pattern exceeds a threshold.

In operation S250, the electronic device 1000 may output defined recommendation settings based on the time point of dissatisfaction being identified. The defined recommendation settings may be prestored in the electronic device 1000.

In an embodiment of the disclosure, when the time point of dissatisfaction is identified, the electronic device 1000 may analyze a current situation of the electronic device 1000. For example, the electronic device 1000 may obtain content information. The content information may include information related to the content itself. The electronic device 1000 may obtain a result of the analysis of the situation as status information of the electronic device 1000.

The electronic device 1000 may select a content group corresponding to the electronic device 1000 based on the status information of the electronic device 1000, and select settings associated with the selected content group, thereby determining settings recommendations.

In an embodiment of the disclosure, when the electronic device 1000 includes a display, the electronic device 1000 may display settings recommendation suggestions on a screen of the display. A processor of the electronic device 1000 may control the display to display the recommendation settings suggestions on the screen. In an embodiment of the disclosure, when the electronic device 1000 is connected to a separate display device, the electronic device 1000 may cause recommendation settings suggestions to be displayed on a screen of the connected display device.

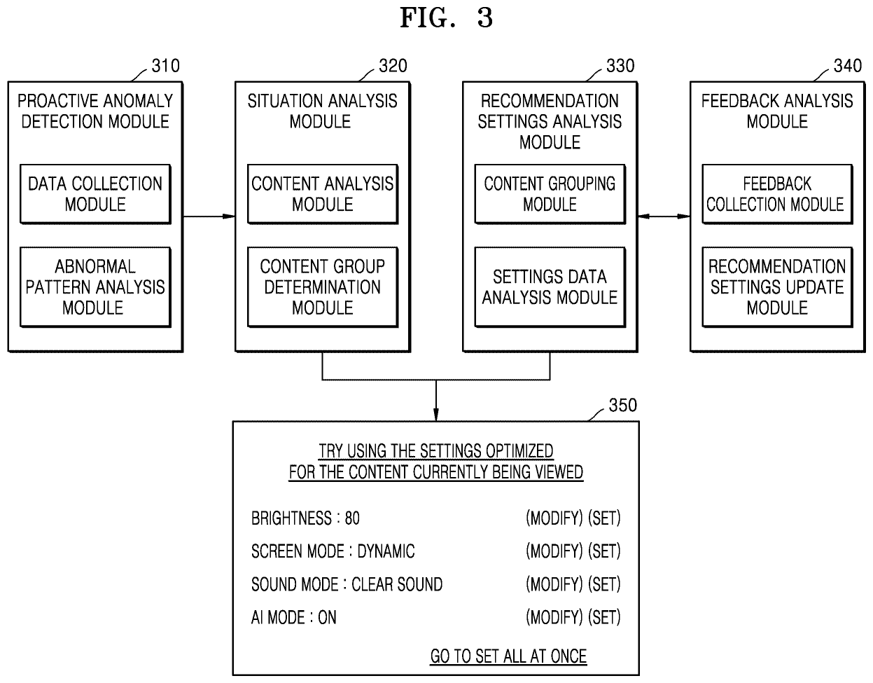

FIG. 3 is a diagram illustrating an example process by which an electronic device provides recommendation settings, according to an various embodiments.

Referring to FIG. 3, the electronic device 1000 may include at least a proactive anomaly detection module 310, a situation analysis module 320, a recommendation settings analysis module 330, and a feedback analysis module 340. Each module illustrated in FIG. 3 may include various circuitry and/or executable program instructions and/or a combination of a series of code and data for implementing a specific function. Each module may process operations corresponding to some of a series of tasks performed by the electronic device 1000 to determine and provide recommendation settings 350, and each module may interact with each other by transmitting and receiving data therebetween. The processor of the electronic device 1000 may process tasks for performing the functions of each module by executing instructions of code of the corresponding module. Moreover, the illustrated modules are for convenience of description and are not necessarily limited to that shown in FIG. 3. Other modules may be added for the electronic device 1000 to provide recommendation settings, and some of the modules may be omitted. In addition, a module may be subdivided into a plurality of modules distinguished according to its detailed functions, and some of the above-described modules may be combined and implemented as a single module. The functions of each module are described below.

The proactive anomaly detection module 310 may include a data collection module and an abnormal pattern analysis module, each of which may include various circuitry and/or executable program instructions. The proactive anomaly detection module 310 may proactively detect an abnormal situation (e.g., user's dissatisfaction state) by analyzing usage patterns.

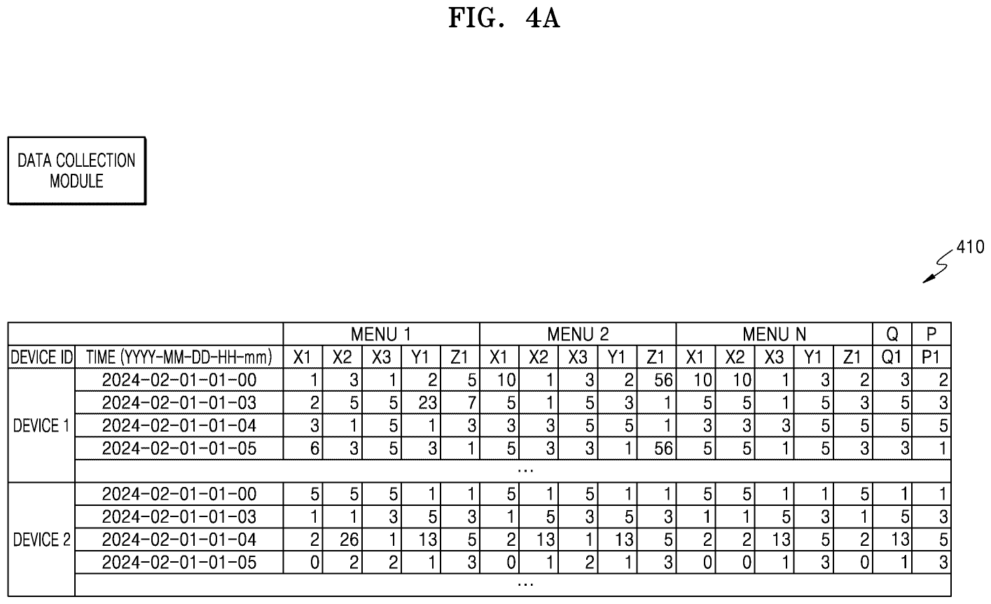

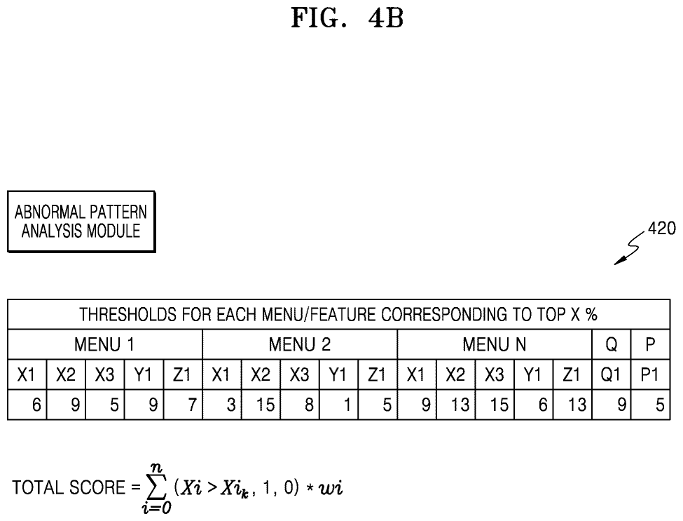

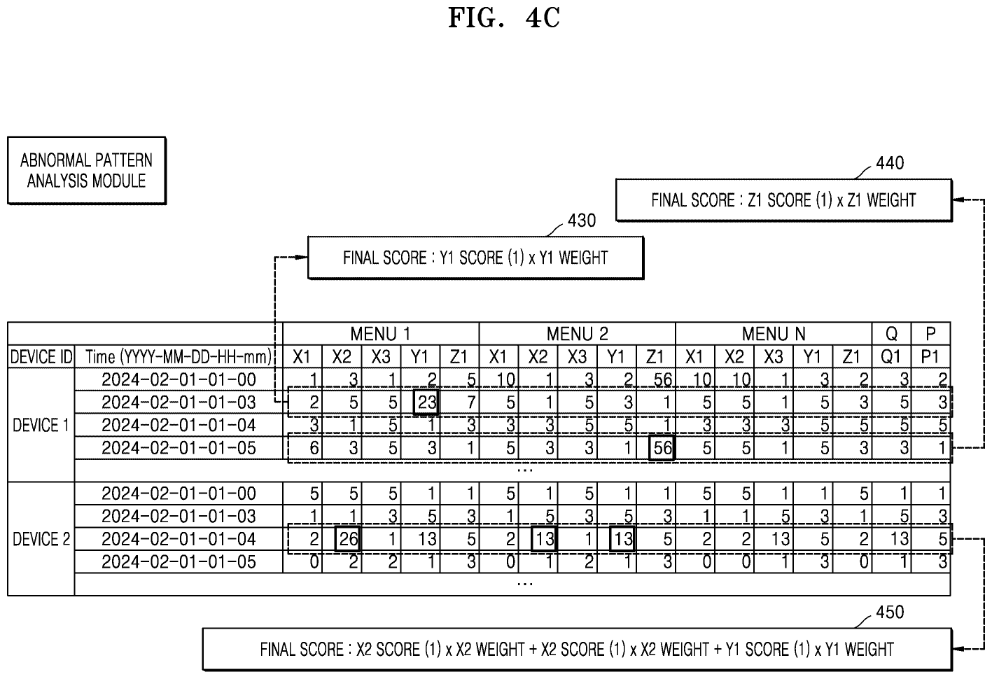

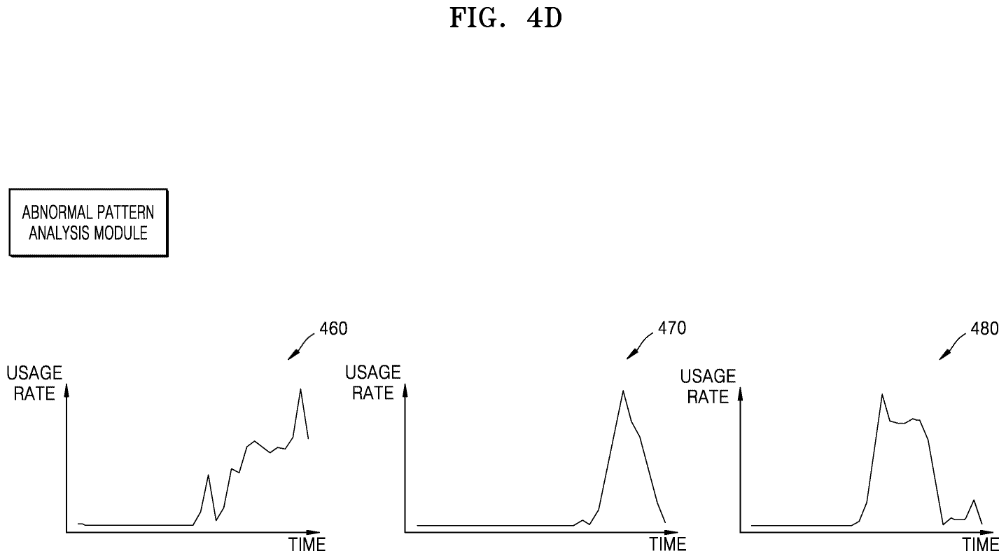

The data collection module may collect behavioral data. The behavioral data may include, for example, but is not limited to, remote control behavioral data, which includes a record of the user manipulating the electronic device 1000 using a remote control, and menu interaction data, which includes a record of the user navigating through, staying in, or making selections from a settings menu. The data collection module is described in greater detail below with reference to FIG. 4A.

The abnormal pattern analysis module may analyze the behavioral data obtained by the data collection module, and detect an abnormal usage pattern to determine a time point of the user's dissatisfaction with the electronic device 1000. The abnormal pattern analysis module may analyze a first usage pattern representing behavioral data over a first time period and a second usage pattern representing behavioral data over a second time period. The first time period may be a relatively short period of time compared to the second time period. In other words, the first usage pattern may be a result of short-term usage pattern analysis, and the second usage pattern may be a result of long-term usage pattern analysis. The abnormal pattern analysis module may determine a time point of the user's dissatisfaction with the electronic device 1000, based on results of the analysis of the first usage pattern and the second usage pattern. The abnormal pattern analysis module is described in greater detail below with reference to FIGS. 4B, 4C and 4D.

The situation analysis module 320 may include a content analysis module and a content group determination module, each of which may include various circuitry and/or executable program instructions. The situation analysis module 320 may first analyze a current situation of the electronic device 1000 in order to provide recommendation settings. The situation analysis module 320 may start tasks for analyzing the current situation of the electronic device 1000 based on a time point of the user's dissatisfaction with the electronic device 1000 being determined.

The content analysis module may analyze at least one of context information or content information. The context information may include, for example, but is not limited to, a type of app/source on which content is played, image quality at which the content is played, a screen aspect ratio at which the content is played, a time at which the content starts playing, a current time, a current day of the week, etc. The content information may include, for example, but is not limited to, a running time of the content, the percentage of remaining time, a genre of the content, a cast, a plot of the content, a broadcast time, a broadcast channel, etc. A content analysis model may analyze the content information and classify the content into subcategories.

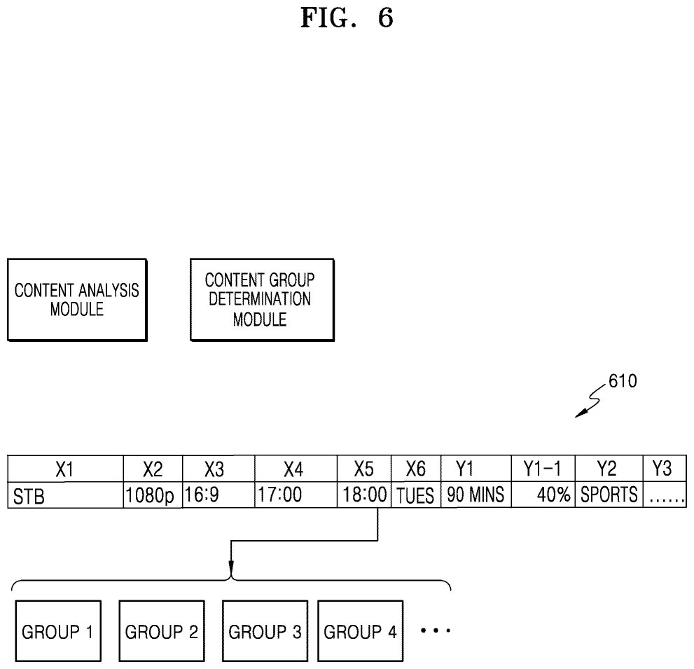

A content group determination model may determine, based on the analyzed content information, a content group to which the current content belongs from among a plurality of content groups. The content analysis module and the content group determination module are described in greater detail below with reference to FIG. 6.

The recommendation settings analysis module 330 may include a content grouping module and a settings data analysis module, each of which may include various circuitry and/or executable program instructions. The recommendation settings analysis module 330 may analyze optimal settings for a current status of the electronic device 1000 and content, and define recommendation settings. The defined recommendation settings may be matched with status information obtained as a result of analysis by the situation analysis module 320.

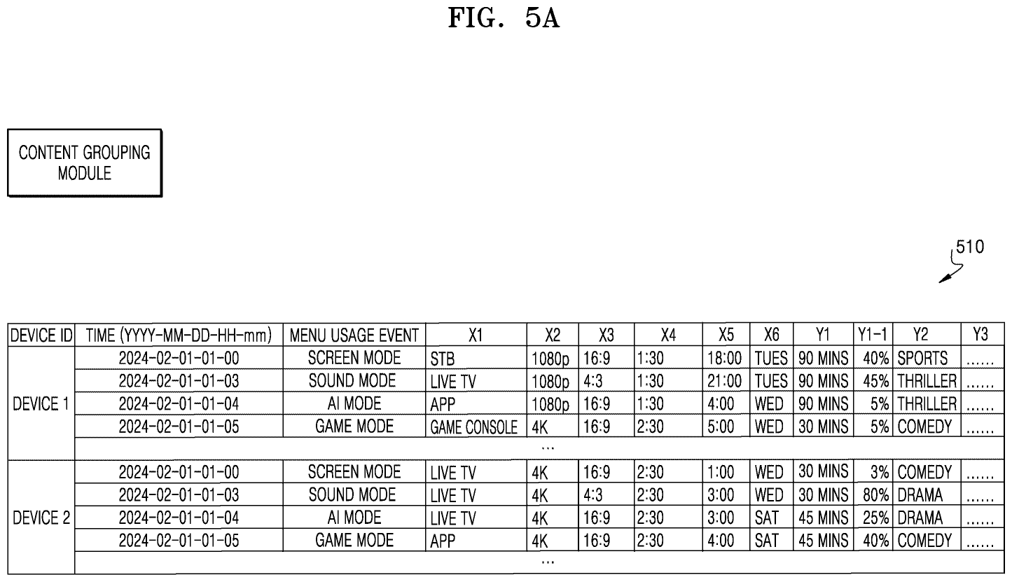

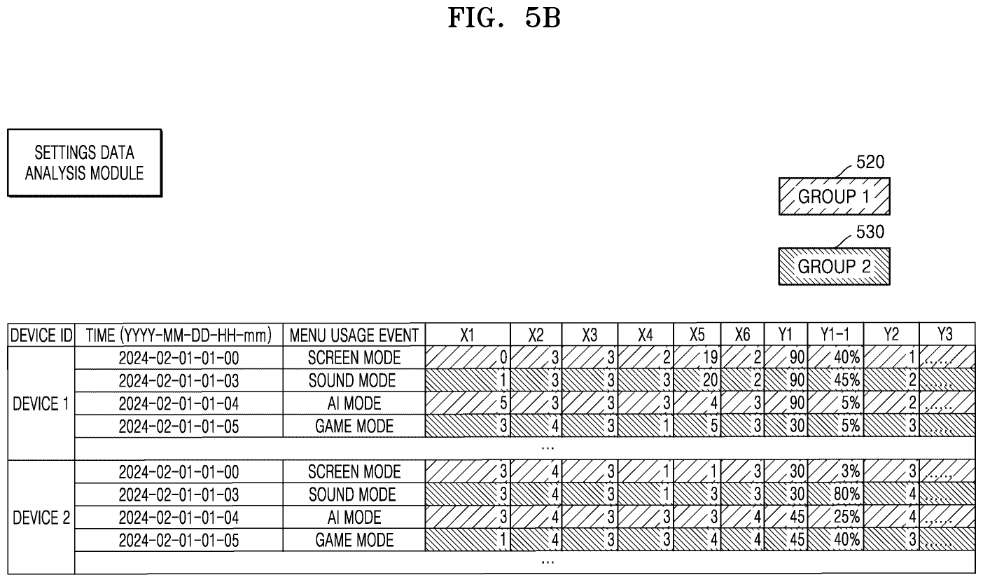

The content grouping module may perform content grouping based on context information and content information. The context information may include information related to playback of the content, and the content information may include information related to the content itself. The content grouping module is described in greater detail below with reference to FIG. 5A.

The settings data analysis module may determine representative settings for each content group. Settings corresponding to a content group may be provided as recommendation settings based on the result of the analysis (e.g., status information) by the situation analysis module 320. The settings data analysis module is described in greater detail below with reference to FIG. 5B.

The feedback analysis module 340 may include a feedback collection module and a recommendation settings update module. The feedback collection module may collect a history of application of recommendation settings as feedback. The recommendation settings module may update algorithms and/or models for providing recommendation settings based on information about the history of the application of the recommendation settings.

FIG. 4A is a diagram illustrating an example operation in which an electronic device collects behavioral data, according to various embodiments.

In an embodiment of the disclosure, the electronic device 1000 may collect and manage behavioral data 410 using the data collection module.

The behavioral data 410 may include remote control behavioral data. The remote control behavioral data may include, but is not limited to, the number of settings changes X (e.g., number of settings changes X1 using a remote control input, number of settings changes X2 via a system user interface (UI), the number of settings changes X3 via voice recognition, etc.), the number of navigation operations Z1 (for moving up, down, left and right) via a remote control input within a menu screen, the number of entries/exits Q1 to/from a menu screen, and the number of system volume changes P1.

The behavioral data 410 may include menu interaction data. The menu interaction data may include, for example, but is not limited to, time Y1 spent on a menu screen.

The behavioral data 410 may be stored separately for each menu item. For example, for each of menu 1, menu 2, . . . , and menu N, features [X1, X2, X3, Y1, Z1] of the behavioral data 410 may be recorded. The behavioral data 410 may be time series data obtained by recording a usage frequency of each feature by time interval. A time gap for recording the usage frequency may be predefined (e.g., specified). For example, the time gap may be 1 minute, but is not limited thereto.

The behavioral data 410 may also be collected from each of the electronic devices other than the electronic device 1000. For example, the behavioral data 410 may be collected for each of device 1, device 2, . . . , and device M. The behavioral data 410 of other electronic devices may be directly transmitted to the electronic device 1000 by the other electronic devices, or may be collected through a server and received by the electronic device 1000. The electronic device 1000 may compare usage patterns (e.g., a first usage pattern and a second usage pattern) for the electronic device 1000 with usage patterns for the other electronic devices.

The behavioral data 410 collected by the data collection module may be used to analyze the user's usage patterns for the electronic device 1000.

FIG. 4B is a diagram illustrating an example operation in which an electronic device analyzes a usage pattern, according to various embodiments.

In an embodiment of the disclosure, the electronic device 1000 may analyze the first usage pattern using the abnormal pattern analysis module. The first usage pattern may be time series data obtained by recording a usage frequency of each feature of the behavioral data by time interval over a first time period. The electronic device 1000 may analyze the first usage pattern by calculating a usage score based on the behavioral data over the first time period.

The electronic device 1000 may obtain thresholds 420 corresponding to features of the behavioral data (hereinafter, thresholds of features). The thresholds 420 of the features may be defined on a menu-by-menu basis and a feature-by-feature basis. The thresholds 420 of the features may be thresholds corresponding to a usage frequency. For example, for the features [X1, X2, X3, Y1, Z1] in menu 1, thresholds [6, 9, 5, 9, 7] may be respectively defined. The thresholds 420 of the features may be defined as different values for different features. The thresholds 420 of the features may also be defined as different values for different menu items.

The electronic device 1000 may identify, based on the thresholds 420 of the features, features whose usage frequencies are greater than or equal to (or above) corresponding thresholds. The electronic device 1000 may calculate a usage score by applying weights respectively corresponding to the identified features. This may be expressed via an equation below. The weights corresponding to the features of the behavioral data may have different values defined for different features. In addition, the weights corresponding to the features of the behavioral data may have different values defined for different menu items.

$$Total Score = {\sum }_{i = 0}^{n} ( Xi > {Xi}_{k} , 1 , 0 ) * wi$$

In the equation above, Xi denotes the number of times an i-th feature of the behavioral data is used, and Xiₖ denotes a threshold corresponding to the i-th feature. wi denotes a weight corresponding to the i-th feature. When the number of times a feature is used is greater than the threshold, a value of 1 is returned so that Xi is multiplied by wi and a usage frequency of the corresponding feature, which is the product, is added to the usage score, and when the number of times the feature is used is less than the threshold, a value of 0 is returned so that the usage frequency of the corresponding feature is not added to the usage score.

In an embodiment of the disclosure, the thresholds 420 of the features and the weights of the features may be learnable values. In other words, the thresholds 420 of the features and the weights of the features may be continuously updated to improve usage pattern analysis. The thresholds 420 of the features and the weights of the features may be calculated by the electronic device 1000, or may be calculated by an external device (e.g., a server), received by the electronic device 1000, and stored therein.

FIG. 4C is a diagram illustrating an example operation in which an electronic device analyzes a usage pattern, according to various embodiments.

In an embodiment of the disclosure, the electronic device 1000 may calculate a usage score based on the behavioral data over the first time period using an abnormal pattern analysis module. Analyzing the first usage pattern, which is a usage pattern over the first time period, may be a short-term usage pattern analysis based on an outlier detection method. For example, the analysis of the first usage pattern may include calculating a usage score for the usage pattern of the electronic device 1000 over the first time period and determining whether the usage score corresponds to an outlier.

Based on the thresholds respectively corresponding to the features of the behavioral data, the electronic device 1000 may identify features whose usage frequencies are greater than or equal to (or above) corresponding thresholds. The electronic device 1000 may calculate a usage score for each time interval by respectively applying corresponding weights to the features identified as having a usage frequency greater than or equal to the threshold.

Examples of calculating usage scores by time interval are described with reference to the behavioral data of device 1 and device 2 illustrated in FIG. 4C. Thresholds respectively corresponding to the features are described on the assumption that they are the thresholds 420 illustrated in FIG. 4B.

A first example 430 of a usage score is a usage score calculated for a time interval of 01:03 on device 1. In the behavioral data for device 1 during the time interval of 01:03, only feature Y1 of menu 1 may be identified as having a value of “23” that is greater than the threshold, while the remaining features of menu 1 and features of the other menus may be identified as having values less than thresholds corresponding to the respective features. In this case, using the usage score calculation equation described above, the first example 430 of the usage score may be calculated below:

$$Y {1}_{M 1} Score ( 1 ) * {weight\_Y1}_{M 1}$$

A second example 440 of a usage score is a usage score calculated for a time interval of 01:05 on device 1. In the behavioral data for device 1 during the time interval of 01:05, only feature Z1 of menu 2 may be identified as having a value of “56” that is greater than the threshold, while the remaining features of menu 2 and features of the other menus may be identified as having values less than thresholds corresponding to the respective features. In this case, using the usage score calculation equation described above, the second example 440 of the usage score may be calculated below:

$$Z {1}_{M 2} Score ( 1 ) * {weight\_Z1}_{M 2}$$

A third example 450 of a usage score is a usage score calculated for a time interval of 01:04 on device 2. In the behavior data for device 2 during the time interval of 01:04, feature X2 of menu 1 and features X2 and Y1 of menu 2 respectively have values greater than or equal to the corresponding thresholds, while the remaining features have values less than the thresholds respectively corresponding to the features. In this case, using the usage score calculation equation described above, the third example 450 of the usage score may be calculated below:

$$[ X {2}_{M 1} Score ( 1 ) * {weight\_X2}_{M 1} ] + [ X {2}_{M 2} Score ( 1 ) * {weight\_X2}_{M 2} ] + [ Y {1}_{M 2} Score ( 1 ) * {weight\_Y1}_{M 2} ]$$

The electronic device 1000 may compare, with a threshold, a usage score obtained by analyzing the first usage pattern of the electronic device 1000. When the usage score is greater than or equal to the threshold, the electronic device 1000 may determine the first usage pattern as an abnormal usage pattern. The threshold for the usage score may be obtained based on results of analysis of first usage patterns of a plurality of devices. For example, usage scores of the plurality of devices may be calculated, and a value corresponding to the top N % of the usage scores may be determined as the threshold for the usage score. For example, among values of the usage scores calculated for the plurality of devices, a value corresponding to the top 1% may be determined as the threshold for the usage score, but the disclosure is not limited thereto.

In an embodiment of the disclosure, the threshold for a usage score may be calculated by the electronic device 1000. The electronic device 1000 may obtain behavioral data of the plurality of devices over the first time period, and determine a threshold for a usage score based on a result of calculating usage scores of the plurality of devices. Alternatively, the threshold for a usage score may be calculated by an external device (e.g., a server), received by the electronic device 1000, and stored therein.

FIG. 4D is a diagram illustrating an example operation in which an electronic device analyzes a usage pattern, according to various embodiments.

In an embodiment of the disclosure, the electronic device 1000 may analyze the second usage pattern using the abnormal pattern analysis module. The second usage pattern may be time series data obtained by recording a usage rate of each feature of behavioral data by time interval over a second time period. The electronic device 1000 may analyze the second usage pattern by comparing, with the stored usage pattern data, the second usage pattern obtained based on the behavioral data over the second time period. The second time period may be longer than the first time period. Analyzing the second usage pattern, which is a usage pattern over the second time period, may be a long-term usage pattern analysis based on a trend analysis method. For example, the analysis of the second usage pattern may include comparing the usage pattern of the electronic device 1000 over the second time period with a usage trend of other electronic devices and determining whether a result of the comparison corresponds to an outlier.

The electronic device 1000 may identify whether the second usage pattern corresponds to an outlier by comparing the second usage pattern with the stored usage pattern data. For example, the electronic device 1000 may determine the second usage pattern to be an abnormal usage pattern when the second usage pattern matches or is similar to a usage pattern having a bottom M % occurrence frequency.

Referring to a first example 460 where a second usage pattern is classified as an abnormal usage pattern, the second usage pattern may be determined to be an abnormal usage pattern when a usage rate by time interval is skewed upward. Furthermore, referring to a second example 470, when a usage rate by time interval suddenly increases significantly, the second usage pattern may be determined to be an abnormal usage pattern. In addition, referring to a third example 480, when a usage rate by time interval remains consistently high, the second usage pattern may be determined to be an abnormal usage pattern. This may refer, for example, to the second usage pattern in each of the first example 460, the second example 470, and the third example 480 being classified as a usage pattern having a bottom M % occurrence frequency within the usage pattern data. Moreover, the examples where the second usage patterns are classified as abnormal usage patterns are for convenience of description and are not intended to limit abnormal cases of the second usage pattern.

The usage pattern having the bottom M % occurrence frequency may be obtained based on analysis results of second usage patterns of a plurality of devices. For example, second usage patterns are respectively generated for the plurality of devices, and among the generated second usage patterns, patterns having a bottom M % occurrence frequency may be identified. The electronic device 1000 may determine a criterion for determining an abnormal usage pattern. For example, among the second usage patterns generated for the plurality of devices, usage patterns having a bottom 1% occurrence frequency may be a criterion for determining an abnormal usage pattern, but the disclosure is not limited thereto.

The electronic device 1000 may cluster the second usage patterns of the plurality of devices using a clustering algorithm. For example, the electronic device 1000 may measure similarity between time series data using a dynamic time warping (DTW) algorithm. For example, the electronic device 1000 may calculate a DTW distance between points in different pieces of time series data. The electronic device 1000 may apply the clustering algorithm based on a DTW distance to group adjacent second usage patterns having similar characteristics. The electronic device 1000 may identify a type of a second usage pattern having a bottom M % occurrence frequency based on a result of the clustering.

In an embodiment of the disclosure, a usage pattern having the bottom M % occurrence frequency may be calculated by the electronic device 1000. The electronic device 1000 may obtain behavioral data of the plurality of devices over the second time period and store usage pattern data used to generate the second usage patterns of the plurality of devices. The electronic device 1000 may determine a usage pattern with a bottom M % occurrence frequency within the usage pattern data as being a type of abnormal usage pattern. The usage pattern data including the second usage patterns of the plurality of devices may be generated by an external device (e.g., a server), and received by the electronic device 1000 and stored therein.

In an embodiment of the disclosure, the electronic device 1000 may identify whether the second usage pattern represents an abnormal usage pattern by comparing the second usage pattern with the stored usage pattern data.

In an embodiment of the disclosure, the electronic device 1000 may detect an abnormal usage pattern using a usage pattern analysis model. The second usage pattern may be used as input data to the usage pattern analysis model. The usage pattern analysis model may be a model that is trained to infer whether a usage pattern is normal or abnormal based on a training dataset including the stored usage pattern data.

FIG. 5A is a diagram illustrating an example operation in which an electronic device generates a content group, according to various embodiments.

In an embodiment of the disclosure, the electronic device 1000 may group and manage a plurality of contents using the content grouping module. To group the contents, the electronic device 1000 may obtain pieces of usage data 510 of a plurality of devices. The pieces of usage data 510 of the plurality of devices may each include, for example, context information and content information, but are not limited thereto. The usage data 510 may be time series data obtained by recording context information and content information by time interval.

Context information may include information X related to playback of content. The context information may include, but is not limited to, a type of app/source X1 on which the content is played (e.g., over-the-top (OTT) application, Live TV application, set-top box, game console, High-Definition Multimedia Interface (HDMI), etc.), image quality X2 at which the content is played (e.g., 1080p, 4K, 8K, etc.), a screen aspect ratio X3 at which the content is played (e.g., 16:9, 4:3, etc.), a time X4 at which the content starts playing, a current time X5, and a current day X6 of the week.

Content information may include information Y related to the content itself. The content information may include, but is not limited to, a running time Y1 of the content, the percentage of remaining time Y1-1, a genre Y2 of the content, a cast Y3, a plot Y4 of the content, a broadcast time, a broadcast channel, etc. The content information may be obtained, for example, from metadata of the content.

The electronic device 1000 may obtain the pieces of usage data 510 of the plurality of devices, which are respectively collected from the electronic device 1000 and other electronic devices. For example, the usage data 510 may be collected for each of device 1, device 2, . . . , and device M. The usage data 510 of the other electronic devices may be directly transmitted to the electronic device 1000 by the other electronic devices, or may be collected via a server and received by the electronic device 1000.

In an embodiment of the disclosure, the electronic device 1000 may cluster the pieces of usage data 510 of the plurality of devices using a clustering algorithm. For example, the electronic device 1000 may measure similarity between time series data using a DTW algorithm. For example, the electronic device 1000 may calculate a DTW distance between points in different pieces of time series data. The electronic device 1000 may apply the clustering algorithm based on a DTW distance to group the adjacent usage data 510 having similar characteristics. Examples of clustering algorithms used may include, for example, K-means clustering, hierarchical clustering, etc., but are not limited thereto.

Based on a result of the clustering, the electronic device 1000 may generate a plurality of content groups by grouping contents having similar characteristics.

FIG. 5B is a diagram illustrating an example operation in which an electronic device determines settings corresponding to a content group, according to various embodiments.

In an embodiment of the disclosure, the electronic device 1000 may determine settings associated with each of the plurality of content groups generated via grouping based on context information and content information. The electronic device 1000 may analyze settings of the plurality of content groups using the settings data analysis module and determine representative settings corresponding to a content group.

For example, as a result of the electronic device 1000 generating the content groups, there may be content classified as group 1 520 and content classified as group 2 530. For contents included in each of the content groups, context information and content information thereof have similar characteristics.

The electronic device 1000 may obtain settings values at the time when contents included in a content group were played. For example, the electronic device 1000 may obtain settings values of the electronic device 1000 at the time when each of the contents classified as group 1 520 was played. In addition, for example, the electronic device 1000 may obtain settings values of the electronic device 1000 at the time when each of the contents classified as group 2 530 was played. The electronic device 1000 may obtain settings values of the electronic device 1000 when each of the contents was played, separately for each content group.

The electronic device 1000 may determine representative settings for each of the content groups. Data classified as a group via clustering have similar characteristics. Therefore, settings values of the electronic device 1000 when each of the contents included in a content group is played may also be similar. The electronic device 1000 may determine representative settings corresponding to a content group in various ways. For example, the electronic device 1000 may determine representative settings using a mean, a median, a mode, etc. of the settings values. The electronic device 1000 may determine representative settings using a variance and a standard deviation of the settings values. The electronic device 1000 may determine representative settings based on a cluster centroid obtained as a result of the clustering.

The electronic device 1000 may store representative settings determined to correspond to each of the content groups.

FIG. 6 is a diagram illustrating an example operation in which an electronic device analyzes a situation and matches optimal settings, according to various embodiments.

In an embodiment of the disclosure, when it is determined by the proactive anomaly detection module that the user of the electronic device 1000 is dissatisfied, the electronic device 1000 may analyze a situation of the electronic device 1000 using the situation analysis module and obtain status information in order to recommend settings of the electronic device 1000.

The electronic device 1000 may analyze content currently being used on the electronic device 1000 using the content analysis module. The electronic device 1000 may obtain at least one of context information or content information of the content currently being used on the electronic device 1000. The context information may include, for example, but is not limited to, a type of app/source on which the content is played, image quality at which the content is played, a screen aspect ratio at which the content is played, a time at which the content starts playing, a current time, a current day of the week, etc. The content information may be included in metadata of the content. The content information may include, for example, but is not limited to, a running time of the content, the percentage of remaining time, a genre of the content, a cast, a plot of the content, a broadcast time, a broadcast channel, etc.

For example, the electronic device 1000 may obtain context information and content information, which are the current usage data 610 of the electronic device 1000. Referring to FIG. 6, the context information included in the usage data 610 of the electronic device 1000 may include, for example, information indicating that a connected source X1 is a set-top box, an image quality X2 is 1080p, a screen aspect ratio X3 is 16:9, a playback start time X4 is 17:00, a current time X5 is 18:00, a current day X6 of the week is Tuesday, etc. In addition, the content information may include, for example, information indicating that a running time Y1 is 90 minutes, the percentage of remaining time Y1-1 is 40%, a genre Y2 is sports, etc.

Using the content group determination module, the electronic device 1000 may determine a content group corresponding to the content being played on the electronic device 1000. Each of a plurality of the content groups may be a collection of contents having similar context information and/or content information.

The electronic device 1000 may determine, based on content analysis information, a content group to which the current content belongs from among the plurality of content groups. For example, when characteristics of content included in group n among group 1 to group N are similar to a content analysis result, the electronic device 1000 may select the content group n as the content group corresponding to the current content.

When the content group is determined, the electronic device 1000 may select settings corresponding to the content group. The selected settings may be provided to the user of the electronic device 1000 as recommendation settings. In this case, settings corresponding to each of the plurality of content groups may be different. For example, group 1 and group 2 have different characteristics and are classified into different groups, so settings corresponding to each group may be different. The settings corresponding to each of the plurality of content groups may be defined by a content grouping process and a settings data analysis process performed by the recommendation settings analysis module. Because this has been described above in the description with respect to FIGS. 5A and 5B, a repeated description thereof may not be repeated here.

The settings for each content group, which are defined by the recommendation settings analysis module, may be used to provide recommendation settings to the user when the user's dissatisfaction state is detected by the proactive anomaly detection module and the settings are matched with status information, which is a result of situation analysis by the situation analysis module according to the user's dissatisfaction state being detected.

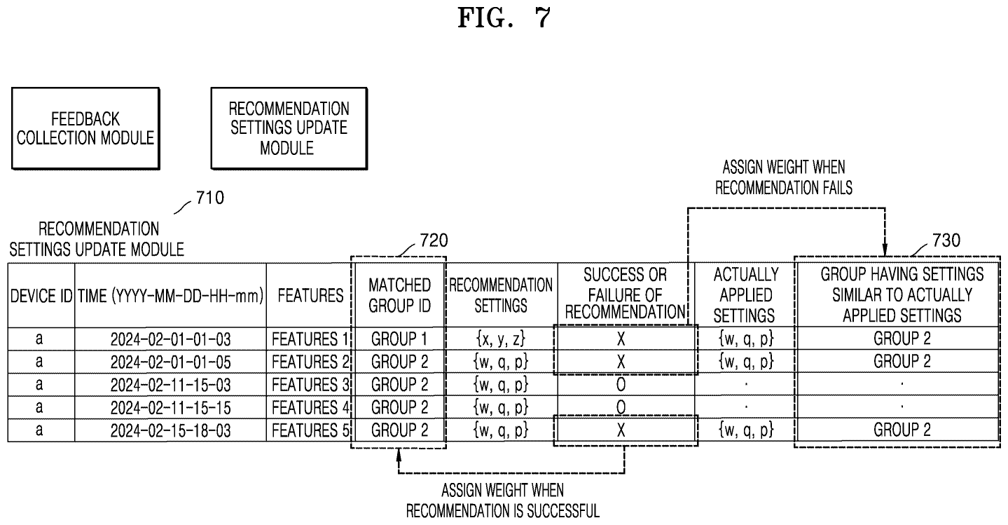

FIG. 7 is a diagram illustrating an example operation in which an electronic device improves settings recommendations using feedback, according to various embodiments.

In an embodiment of the disclosure, the electronic device 1000 may update algorithms and/or models for providing recommendation settings using the feedback collection module and the recommendation settings update module.

In an embodiment of the disclosure, the electronic device 1000 may obtain recommendation history information 710. The recommendation history information 710 may include, but is not limited to, device identification information of a device to which recommendation settings were provided, information about a time when a recommendation was provided, information about features used to provide recommendation settings, information 720 about a content group matched, information about recommendation settings exposed to the user, information about success or failure of the recommendation, information about actually applied settings, and information 730 about a content group having settings similar to the actually applied settings.

The electronic device 1000 may apply a weight to at least one of a plurality of content groups based on the recommendation history information 710.

For example, the electronic device 1000 may identify whether the recommended settings have been applied based on the success or failure of the recommendation and the information 720 about a content group matched, and when the recommendation settings have been applied, may apply a weight to the matched content group. When the recommended settings have been applied, it may refer, for example, to the recommendation being successful. Thus, the electronic device 1000 may apply a weight to the matched content group to ensure that the likelihood of a recommendation for the matched content group is strengthened when the electronic device 1000 provides another recommendation settings at a later time. In this case, when the electronic device 1000 is playing the same or similar content at a later time, it may be more likely that the same or similar recommendation settings as the existing recommendation will be provided.

For example, the electronic device 1000 may apply a weight to a content group having settings similar to the actually applied settings based on the success or failure of the recommendation, information about the actually applied settings, and the information 730 about the content group having settings similar to the actually applied settings. When the recommended settings have not been applied, may refer, for example, to the recommendation failing. Therefore, the electronic device 1000 may apply a weight to a content group having settings similar to settings that were actually applied when the recommendation failed, such that the likelihood of recommendation for the content group having settings similar to the actually applied settings is strengthened when the electronic device 1000 provides another recommendation settings at a later time. In this case, when the electronic device 1000 is playing the same or similar content at a later time, it may be more likely that recommendation settings that is different from the existing recommendation will be provided.

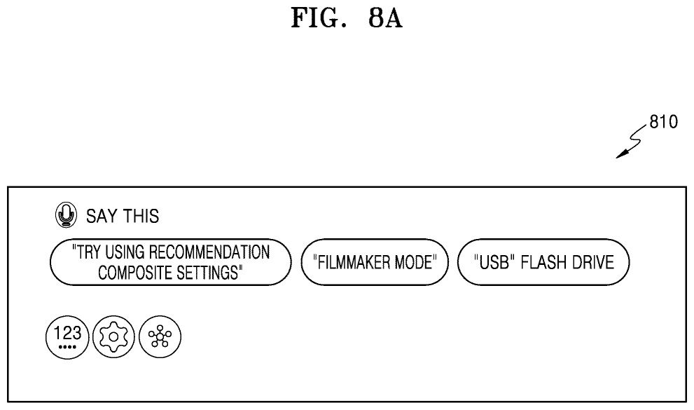

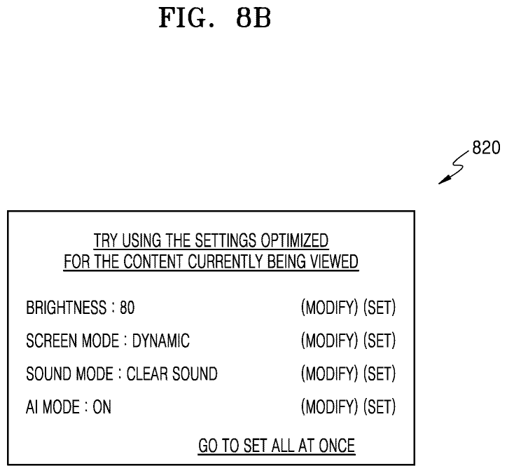

FIG. 8A is a diagram illustrating an example in which an electronic device provides recommendation settings, according to various embodiments.

In an embodiment of the disclosure, the electronic device 1000 may initiate a series of operations for providing recommendation settings while the electronic device 1000 is operating. The electronic device 1000 may collect and analyze behavioral data while the electronic device 1000 is operating. The electronic device 1000 may determine that the user is dissatisfied by analyzing the behavioral data.

Based on determining that the user is dissatisfied, the electronic device 1000 may proactively provide the user with recommendation settings for addressing the user's dissatisfaction with the settings.

The electronic device 1000 may display a UI 810 that prompts the user to apply recommendation settings while maintaining the existing operation of the electronic device 1000 (e.g., while continuing to play content, etc.). Specifically, when the recommendation settings are determined, the electronic device 1000 may display, on the screen, via the UI 810, commands “Apply recommendation settings”, “Filmmaker mode”, etc., to cause the recommendation settings to be applied, along with a guide “Say this to apply the recommended composite settings”.

The electronic device 1000 may apply the recommendation settings based on a voice input from the user. For example, the electronic device 1000 may change settings values of the electronic device 1000 according to a voice command such as “Apply recommendation settings”. For example, the electronic device 1000 may change settings values of the electronic device 1000 according to a voice command such as “Filmmaker mode”.

The user's voice input may be obtained by an input device (e.g., a microphone) included in the electronic device 1000. Alternatively, the user's voice input may be obtained by a user device capable of communicating with the electronic device 1000 and transmitted to the electronic device 1000. The user device may be a device that provides installation of an application capable of interacting with the electronic device 1000, or includes a voice input device (e.g., a microphone). For example, the user device may include a smartphone, an AI speaker, etc., but is not limited thereto. The user's voice input may be obtained by an input device (e.g., a microphone) included in a remote control and transmitted to the electronic device 1000.

In an embodiment of the disclosure, the recommendation settings may be applied by other types of input that may be processed in a similar manner to the user's voice input. For example, the electronic device 1000 may change settings values of the electronic device 1000 according to a text command such as “Apply recommendation settings”. A text input may include, but is not limited to, an input via an input device (e.g., a touch screen) of the electronic device 1000, an input via a remote control (e.g., clicking on a screen using the remote control, input via a keypad within the remote control, etc.), a text input via a user device, etc.

The electronic device 1000 may apply recommendation settings based on a remote control input from the user. For example, the electronic device 1000 may change settings values of the electronic device 1000 based on a user input for selecting a command for applying the recommendation settings, which is displayed on the screen, using the remote control.

However, the UI 810 illustrated in FIG. 8A is merely an example of a method of providing settings recommendations. The electronic device 1000 may provide a user interface configured in various ways to induce the application of settings recommendations.

FIG. 8B is a diagram illustrating an example in which an electronic device provides recommendation settings, according to various embodiments.

The electronic device 1000 may display a UI 820 that prompts the user to apply recommendation settings while maintaining the existing operation of the electronic device 1000 (e.g., while continuing to play content, etc.). The UI 820 may include, but is not limited to, settings items, values of the settings items, UI elements (e.g., links, buttons, etc.) for modifying/applying recommended settings items, and UI elements (e.g., links, buttons, etc.) for bulk application.

For example, referring to the UI 820 that suggests recommendation settings, settings values for various settings items, such as Brightness: 80, Screen Mode: Dynamic, Sound mode: Clear sound, AI Mode: On, etc. may be included. In addition, UI elements (e.g., links, buttons, etc.) that allow each of the settings items to be individually modified or applied may be included, and UI elements (e.g., links, buttons, etc.) that allow settings values for the recommended settings items to be applied at once may be included.

In an embodiment of the disclosure, the electronic device 1000 may apply the recommendation settings based on a user input. The user input may be, for example, a voice input, a remote control input, or a touch input, but the type of input is not limited thereto.

In an embodiment of the disclosure, the electronic device 1000 may automatically apply the recommendation settings and output a notification indicating a result of the application.

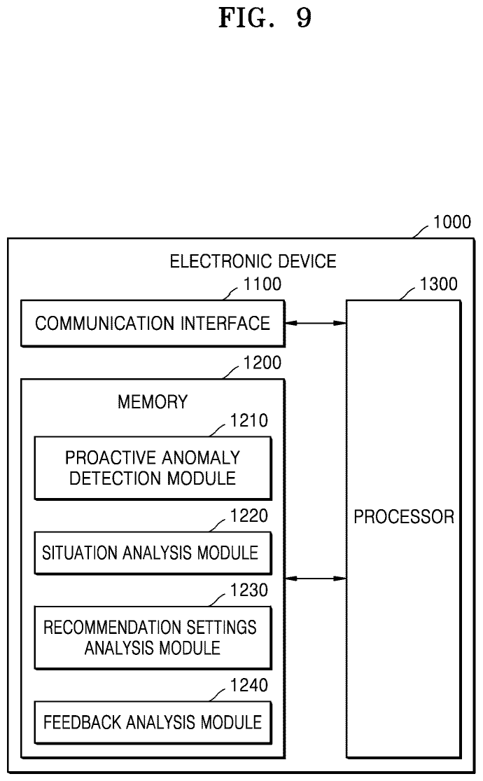

FIG. 9 is a block diagram illustrating an example configuration of an electronic device according to various embodiments.

In an embodiment of the disclosure, the electronic device 1000 may include a communication interface (e.g., including communication circuitry) 1100, a memory 1200, and a processor (e.g., including processing circuitry) 1300.

The communication interface 1100 may include various communication circuitry and perform data communication with other electronic devices according to control by the processor 1300. The communication interface 1100 may include a communication circuit.

The communication interface 1100 is capable of performing data communication between the electronic device 1000 and another electronic device (e.g., a server) using at least one of data communication methods including, for example, wired local area network (LAN) (e.g., Ethernet), wireless LAN (e.g., Wi-Fi), cellular networks (4th generation (4G), 5th generation (5G), etc.), Bluetooth, Bluetooth Low Energy (BLE), ZigBee, Infrared Data Association (IrDA), near field communication (NFC), radio frequency (RF) communication, and various other types of known wireless/wired communication technologies. The communication interface 1100 may include communication circuitry designed to utilize the above-described communication methods.

The electronic device 1000 may transmit and receive data for providing recommendation settings to and from another electronic device (e.g., a server) using the communication interface 1100.

The memory 1200 may include various types of memory. The memory 1200 may include non-volatile memory, including at least one of a flash memory-type memory, a hard disk-type memory, a multimedia card micro-type memory, a card-type memory (e.g., a Secure Digital (SD) or extreme Digital (XD) memory, etc.), read-only memory (ROM), electrically erasable programmable ROM (EEPROM), PROM, magnetic memory, magnetic disk, or optical disk, and volatile memory such as random access memory (RAM) or static RAM (SRAM).

The memory 1200 may store one or more instructions and one or more programs that cause the electronic device 1000 to operate to generate and provide recommendation settings. For example, the memory 1200 may store instructions and programs for implementing functions of a proactive anomaly detection module 1210, a situation analysis module 1220, a recommendation settings analysis module 1230, and a feedback analysis module 1240, each of which may include executable program instructions. Moreover, the modules stored in the memory 1200 are for convenience of description and are not necessarily limited thereto. Other modules may be added to implement the above-described embodiments of the disclosure, and some of the modules may be omitted. In addition, a module may be subdivided into a plurality of modules distinguished according to its detailed functions, and some of the above-described modules may be combined and implemented as a single module.

The processor 1300 may include various processing circuitry and control operations of the electronic device 1000. The processor 1300 may include processing circuitry. For example, the processor 1300 may execute one or more instructions of a program stored in the memory 1200 to control all operations of the electronic device 1000 for detecting the user's dissatisfaction state and providing recommendation settings. The processor 1300 may be configured as one or more processors.

For example, the processor 1300 may include, but is not limited to, at least one of a central processing unit (CPU), a microprocessor, a graphics processing unit (GPU), application-specific integrated circuits (ASICs), digital signal processors (DSPs), digital signal processing devices (DSPDs), programmable logic devices (PLDs), field programmable gate arrays (FPGAs), an application processor (AP), a neural processing unit (NPU), and/or a dedicated AI processor designed with a hardware structure specialized for processing AI models. Thus, the processor 1300 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 1300 may execute the proactive anomaly detection module 1210 to proactively detect the user's dissatisfaction state. For example, the processor 1300 may detect an abnormal usage pattern and the user's dissatisfaction state using the proactive anomaly detection module through a first usage pattern analysis, which is a short-term usage pattern analysis, and a second usage pattern analysis, which is a long-term usage pattern analysis. Because the operations of the proactive anomaly detection module 1210 have already been described in the description with respect to the previous drawings, a repeated description thereof may not be repeated here.

The processor 1300 may execute the situation analysis module 1220 to analyze a current situation of the electronic device 1000. When the user's dissatisfaction state is detected, the processor 1300 may analyze the current situation of the electronic device 1000 to identify similar content groups. The similar content groups may have defined recommendation settings corresponding to the groups. Because the operations of the situation analysis module 1220 have already been described in the description with respect to the previous drawings, a repeated description thereof may not be repeated here.

The processor 1300 may execute the recommendation settings analysis module 1230 to define settings that may be used as recommendation settings. Using the recommendation settings analysis module 1230, the processor 1300 may determine a plurality of content groups by clustering usage data of a plurality of devices. The processor 1300 may determine representative settings items and representative settings values corresponding to content groups using the recommendation settings analysis module 1230. Because the operations of the recommendation settings analysis module 1230 have already been described in the description with respect to the previous drawings, a repeated description thereof may not be repeated here.

The processor 1300 may execute the feedback analysis module 1240 to update algorithms and/or models for providing recommendation settings. Using the feedback analysis module 1240, the processor 1300 may identify whether recommendation settings are actually applied or not applied, and apply a weight to content group information used to provide the recommendation settings, based on a result of the identification. Because the operations of the feedback analysis module 1240 have already been described in the description with respect to the previous drawings, a repeated description thereof may not be repeated here.

When the processor 1300 are configured as one or more processors, the operations according to the disclosure may be performed by the one or more processors individually or collectively executing instructions and/or programs stored in the memory 1200. When a method according to an embodiment of the disclosure includes a plurality of operations, the plurality of operations may be performed by the one processor 1300 or the plurality of processors 1300.

For example, when a first operation, a second operation, and a third operation are performed according to a method of an embodiment of the disclosure, the first operation, the second operation, and the third operation may all be performed by a first processor, or some of the first to third operations may be performed by the first processor (e.g., a general-purpose processor) while the remaining operations may be performed by a second processor (e.g., a dedicated AI processor). Computations for training/inference of AI models may be performed by the dedicated AI processor, which is an example of the second processor. However, the disclosure is not limited thereto.

The one or more processors according to the disclosure may be implemented as a single-core processor or as a multi-core processor. When a method according to an embodiment of the disclosure includes a plurality of operations, the plurality of operations may be performed by a single core, or may be performed by a plurality of cores included in the one or more processors.

Although not shown in FIG. 9, the electronic device 1000 may further include additional components to perform the operations described in the above-described embodiment of the disclosure. For example, the electronic device 1000 may further include a display, a microphone, an input/output (I/O) interface, etc.

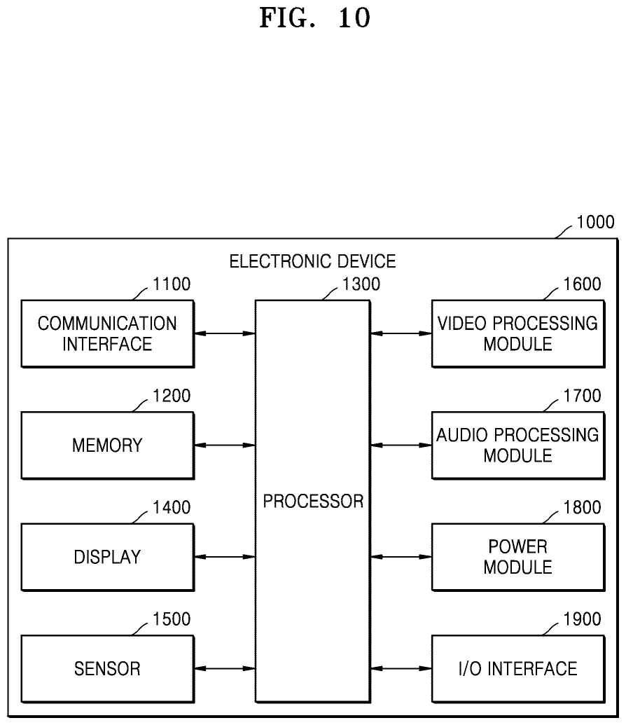

FIG. 10 is a block diagram illustrating an example configuration of an electronic device according to various embodiments.

In an embodiment of the disclosure, the electronic device 1000 may include a communication interface (e.g., including communication circuitry) 1100, a memory 1200, a processor (e.g., including processing circuitry) 1300, a display 1400, a sensor 1500, a video processing module (e.g., including video processing circuitry) 1600, an audio processing module (e.g., including audio processing circuitry) 1700, a power module (e.g., including a power supply) 1800, and an I/O interface (e.g., including various circuitry) 1900.

The communication interface 1100, the memory 1200, and the processor 1300 of FIG. 10 respectively correspond to the communication interface 1100, the memory 1200, and the processor 1300 of FIG. 9, and thus, repeated descriptions thereof may not be repeated here.

The display 1400 may output an image signal onto a screen of the electronic device 1000 according to control by the processor 1300. For example, the electronic device 1000 may output a UI including one or more recommendation settings on the display 1400.

The sensor 1500 may obtain sensor data. The sensor 1500 may be one or more sensors. The processor 1300 may process the sensor data to obtain information. The sensor may include, but is not limited to, an infrared (IR) receiver for detecting a remote control signal.

The video processing module 1600 may include various circuitry and performs processing on video data played by the electronic device 1000. The video processing module 1600 may perform various types of image/video processing, such as decoding, scaling, noise reduction, frame rate conversion, resolution conversion, rendering, etc., on the video data. The display 1400 may generate a driving signal by converting an image signal, a data signal, an on-screen display (OSD) signal, a control signal, etc. processed by the processor 1300, and display an image according to the driving signal.

The audio processing module 1700 may include various circuitry and performs processing on audio data played by the electronic device 1000. The audio processing module 1700 may perform various types of processing, such as decoding, amplification, noise reduction, etc., on the audio data.

The power module 1800 may include a power supply that supplies, under control of the processor 1300, power input from an external power source to internal components of the electronic device 1000. The power module 1800 may also supply, according to control by the processor 1300, power output from one or more batteries located within the electronic device 1000 to the internal components.

The I/O interface 1900 may include various circuitry and processes an input/an output from outside of the electronic device 1000. The I/O interface 1900 receives video (e.g., a moving image, etc.), audio (e.g., voice, music, etc.), additional information (e.g., an electronic program guide (EPG), etc.), and the like. The I/O interface 1900 may include one of an HDMI, a Mobile High-Definition Link (MHL), a Universal Serial Bus (USB), a DisplayPort (DP), a Thunderbolt, a Video Graphics Array (VGA) port, a red, green, and blue (RGB) port, a D-subminiature (D-sub), a Digital Visual Interface (DVI), a component jack, a PC port, and an audio jack. For example, the I/O interface 1900 may be implemented to include a plurality of modules (e.g., a USB port, an HDMI port, etc.) for implementing the above-described input/output methods. The electronic device 1000 may be connected to external devices, such as a display, a camera, a microphone, a speaker, a touch pad, etc., via the I/O interface 1900.

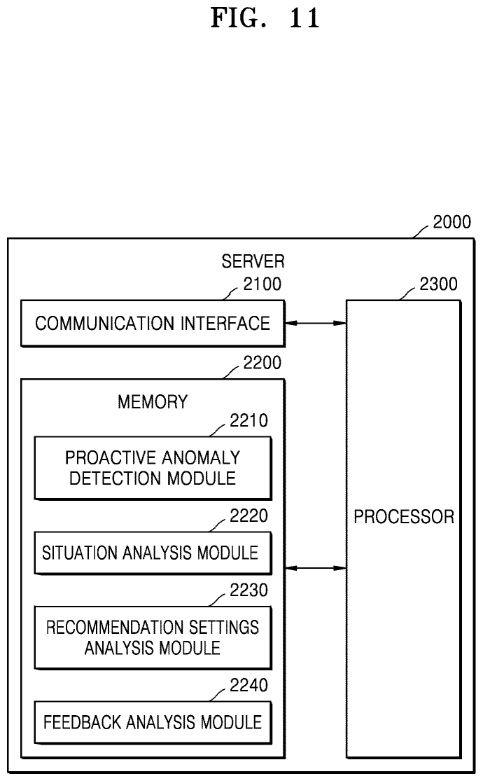

FIG. 11 is a block diagram illustrating an example configuration of a server according to various embodiments.

In an embodiment of the disclosure, the operations performed by the electronic device 1000 or by the electronic device 1000 interacting with a server 2000 may be performed solely by the server 2000.

The server 2000 may include a communication interface (e.g., including communication circuitry) 2100, a memory 2200, and a processor (e.g., including processing circuitry) 2300. The server 2000 may be a computing device with higher performance than the electronic device 1000, capable of processing complex computations and tasks using large amounts of data, such as training, inference, management, and distribution of AI models (e.g., a usage pattern analysis model, a dissatisfaction detection model, etc.).

The communication interface 2100 may include various communication circuitry and perform data communication with other electronic devices under control of the processor 2300. The communication interface 2100 may include a communication circuit.

The communication interface 2100 is capable of performing data communication between the server 2000 and another electronic device (e.g., the electronic device 1000) using at least one of data communication methods including, for example, wired LAN (e.g., Ethernet), wireless LAN (e.g., Wi-Fi), cellular networks (4G, 5G, etc.) Bluetooth, BLE, ZigBee, IrDA, NFC, RF communication, and various other types of known wireless/wired communication technologies. The communication interface 2100 may include communication circuitry designed to utilize the above-described communication methods.

The memory 2200 may include various types of memory. The memory 2200 may include non-volatile memory, including at least one of a flash memory-type memory, a hard disk-type memory, a multimedia card micro-type memory, a card-type memory (e.g., an SD or XD memory, etc.), ROM, EEPROM, PROM, magnetic memory, magnetic disk, or optical disk, and volatile memory such as RAM or SRAM.

The memory 2200 may store one or more instructions and one or more programs that cause server 2000 to operate to generate and provide recommendation settings. For example, the memory 2200 may store instructions and programs for implementing functions of a proactive anomaly detection module 2210, a situation analysis module 2220, a recommendation settings analysis module 2230, and a feedback analysis module 2240. Because the modules stored in the server 2000 respectively correspond to the modules stored in the electronic device 1000, repeated descriptions thereof may not be repeated here.

The processor 2300 may include various processing circuitry and control operations of the server 2000. The processor 2300 may include processing circuitry. For example, the processor 2300 may execute one or more instructions of a program stored in the memory 2200 to control all operations of the server 2000 for detecting a user's dissatisfaction state and providing recommendation settings. The processor 2300 may be one or more processors.

For example, the processor 2300 may include, but is not limited to, at least one of a CPU, a microprocessor, a GPU, ASICs, DSPs, DSPDs, PLDs, FPGAs, an AP, an NPU, or a dedicated AI processor designed with a hardware structure specialized for processing AI models. Thus, the processor 2300 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment of the disclosure, the electronic device 1000 may operate using a cloud-based AI approach in which the electronic device 1000 does not operate an AI model on-device but receives an output result from an AI model running on the server 2000. For example, the usage pattern analysis model, the dissatisfaction detection model, etc. of the disclosure may be run on the server 2000. The electronic device 1000 may transmit input data for the AI model to the server 2000, and the server 2000 may transmit output data from the AI model to the electronic device 1000.

The disclosure relates to a method and an electronic device for proactively detecting a user's dissatisfaction state by analyzing the user's behavior while the electronic device is operating and providing optimal settings recommendations. The technical solutions to be achieved in the disclosure are not limited to those described above, and other technical solutions not described will be clearly understood by one of ordinary skill in the art from the description herein.

According to an example embodiment of the disclosure, a method, performed by an electronic device, of providing recommendation settings may be provided.

The method may include obtaining a first usage pattern based on a usage score obtained from behavioral data over a first time period, corresponding to an interaction of a user with the electronic device.

The method may include obtaining a second usage pattern, based on behavioral data over a second time period longer than the first time period, corresponding to an interaction of the user with the electronic device, and stored usage pattern data.

The method may include controlling outputting of recommendation settings based on a time point of dissatisfaction with use of the electronic device, which is identified based on the first usage pattern and the second usage pattern.

The controlling of the outputting of the recommendation settings may include obtaining status information of the electronic device when the time point of the dissatisfaction is identified.

The controlling of the outputting of the recommendation settings may include controlling outputting of, as the recommendation settings, settings associated with a content group corresponding to the status information from among a plurality of content groups.

Settings respectively associated with the plurality of content groups may be different from each other.

The settings respectively associated with the plurality of content groups may be a plurality of settings stored, respectively corresponding to the plurality of content groups based on status information and grouped content information that are obtained from a plurality of devices.

The obtaining of the first usage pattern may include calculating the usage score based on usage frequencies of features included in the behavioral data over the first time period.

The obtaining of the first usage pattern may include identifying a usage pattern as an abnormal usage pattern when the usage score is greater than or equal to a first threshold.

The calculating of the usage score may include identifying, based on second thresholds respectively corresponding to the features of the behavioral data, features whose usage frequencies are greater than or equal to corresponding second thresholds.

The calculating of the usage score may include obtaining a usage score for each time interval by applying weights respectively corresponding to the identified features.

The second thresholds respectively corresponding to the usage frequencies of the features and the weights respectively corresponding to the features may be different for each feature and may be learnable.

The obtaining of the second usage pattern may include identifying an abnormal usage pattern via a usage pattern analysis model that takes the behavior data over the second time period as input data.

The usage pattern analysis model may be trained based on a training dataset including the stored usage pattern data.

The method may include applying a weight to at least one of the plurality of content groups based on history information indicating a history of application of the recommendation settings.

The applying of the weight to the at least one of the plurality of content groups may include applying the weight to a content group corresponding to the recommendation settings, based on the recommendation settings having been applied to the electronic device.

The applying of the weight to the at least one of the plurality of content groups may include applying the weight to a content group having settings similar to settings applied to the electronic device, based on the recommendation setting having not been applied to the electronic device.

The controlling of the outputting of the recommendation settings may include controlling automatic application of the recommendation settings and outputting of information corresponding to a result of the application.

According to an example embodiment of the disclosure, an electronic device for providing recommendation settings may be provided.

The electronic device may include a communication interface, comprising communication circuitry, at least one processor, comprising processing circuitry, and a memory storing instructions.

At least one processor, individually and/or collectively, may be configured to execute the instructions and to cause the electronic device to obtain a first usage pattern based on a usage score obtained from behavioral data over a first time period, corresponding to an interaction of a user with the electronic device.

At least one processor, individually and/or collectively, may be configured to cause the electronic device to obtain a second usage pattern, based on behavioral data over a second time period longer than the first time period, corresponding to an interaction of the user with the electronic device, and stored usage pattern data.

At least one processor, individually and/or collectively, may be configured to cause the electronic device to control outputting of recommendation settings based on a time point of dissatisfaction with use of the electronic device, which is identified based on the first usage pattern and the second usage pattern.

At least one processor, individually and/or collectively, may be configured to cause the electronic device to obtain status information of the electronic device when the time point of the dissatisfaction is identified.

At least one processor, individually and/or collectively, may be configured to cause the electronic device to control outputting of, as the recommendation settings, settings associated with a content group corresponding to the status information from among a plurality of content groups.

Settings respectively associated with the plurality of content groups may be different from each other.

The settings respectively associated with the plurality of content groups may be a plurality of settings stored, respectively corresponding to the plurality of content groups based on status information and grouped content information that are obtained from a plurality of devices.

At least one processor, individually and/or collectively, may be configured to cause the electronic device to calculate the usage score based on usage frequencies of features included in the behavioral data over the first time period.

At least one processor, individually and/or collectively, may be configured to cause the electronic device to identify a usage pattern as an abnormal usage pattern when the usage score is greater than or equal to a first threshold.

At least one processor, individually and/or collectively, may be configured to cause the electronic device to identify, based on second thresholds respectively corresponding to the features of the behavioral data, features whose usage frequencies are greater than or equal to corresponding second thresholds.

At least one processor, individually and/or collectively, may be configured to cause the electronic device to obtain a usage score for each time interval by applying weights respectively corresponding to the identified features.

The second thresholds respectively corresponding to the usage frequencies of the features and the weights respectively corresponding to the features may be different for each feature and may be learnable.

At least one processor, individually and/or collectively, may be configured to cause the electronic device to identify an abnormal usage pattern via a usage pattern analysis model that takes the behavior data over the second time period as input data.

The usage pattern analysis model may be trained based on a training dataset including the stored usage pattern data.

At least one processor, individually and/or collectively, may be configured to cause the electronic device to apply a weight to at least one of the plurality of content groups based on history information indicating a history of application of the recommendation settings.

At least one processor, individually and/or collectively, may be configured to cause the electronic device to apply the weight to a content group corresponding to the recommendation settings, based on the recommendation settings having been applied to the electronic device.

At least one processor, individually and/or collectively, may be configured to cause the electronic device to apply the weight to a content group having settings similar to settings applied to the electronic device, based on the recommendation setting having not been applied to the electronic device.

At least one processor, individually and/or collectively, may be configured to cause the electronic device to control automatic application of the recommendation settings and outputting of information corresponding to a result of the application.

Moreover, embodiments of the disclosure may be implemented in the form of recording media including instructions executable by a computer, such as a program module executed by the computer. The computer-readable recording media may be any available media that are accessible by a computer, and include both volatile and nonvolatile media and both removable and non-removable media. Furthermore, the computer-readable recording media may include computer storage media and communication media. The computer storage media include both volatile and nonvolatile and both removable and non-removable media implemented using any method or technology for storage of information such as computer-readable instructions, data structures, program modules, or other data. The communication media typically embody computer-readable instructions, data structures, program modules, or other data in a modulated data signal.

A computer-readable storage medium may be provided in the form of a non-transitory storage medium. In this regard, the ‘non-transitory storage medium’ may refer, for example to the storage medium not including a signal (e.g., an electromagnetic wave) and being a tangible device, and the term does not differentiate between where data is semi-permanently stored in the storage medium and where the data is temporarily stored in the storage medium. For example, the ‘non-transitory storage medium’ may include a buffer for temporarily storing data.

According to an embodiment of the disclosure, methods according to various embodiments of the disclosure may be included in a computer program product when provided. The computer program product may be traded, as a product, between a seller and a buyer. The computer program product may be distributed in the form of a machine-readable storage medium (e.g., compact disc ROM (CD-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

The above description of the disclosure is provided for illustration, and it will be understood by those of ordinary skill in the art that changes in form and details may be readily made therein without departing from technical idea or essential features of the disclosure. Accordingly, the above-described embodiments of the disclosure and all aspects thereof are merely examples and are not limiting. For example, each component defined as an integrated component may be implemented in a distributed fashion, and likewise, components defined as separate components may be implemented in an integrated form.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method, performed by an electronic device, of providing recommendation settings, the method comprising:
obtaining a first usage pattern based on a usage score obtained from behavioral data over a first time period, corresponding to an interaction of a user with the electronic device;
obtaining a second usage pattern, based on behavioral data over a second time period longer than the first time period, corresponding to an interaction of the user with the electronic device, and stored usage pattern data; and
controlling outputting of recommendation settings based on a time point of dissatisfaction with use of the electronic device, identified based on the first usage pattern and the second usage pattern.

2. The method of claim 1, wherein:
the controlling of the outputting of the recommendation settings comprises:
obtaining status information of the electronic device based on the time point of the dissatisfaction being identified; and
controlling outputting of, as the recommendation settings, settings associated with a content group corresponding to the status information from among a plurality of content groups,
wherein settings respectively associated with the plurality of content groups may be different from each other.

3. The method of claim 2, wherein the settings respectively associated with the plurality of content groups include a plurality of settings stored, respectively corresponding to the plurality of content groups based on status information and grouped content information that are obtained from a plurality of devices.

4. The method of claim 1, wherein:
the obtaining of the first usage pattern comprises:
calculating the usage score based on usage frequencies of features included in the behavioral data over the first time period; and
identifying a usage pattern as an abnormal usage pattern based on the usage score being greater than or equal to a first threshold.

5. The method of claim 4, wherein:
the calculating of the usage score comprises:
identifying, based on second thresholds respectively corresponding to the features of the behavioral data, features having usage frequencies greater than or equal to corresponding second thresholds; and
obtaining a usage score for each time interval by applying weights respectively corresponding to the identified features,
wherein the second thresholds respectively corresponding to the usage frequencies of the features and the weights respectively corresponding to the features are different for each feature and are learnable.

6. The method of claim 1, wherein the obtaining of the second usage pattern comprises identifying an abnormal usage pattern via a usage pattern analysis model using the behavior data over the second time period as input data, wherein the usage pattern analysis model is trained based on a training dataset including the stored usage pattern data.

7. The method of claim 2, further comprising applying a weight to at least one of the plurality of content groups based on history information indicating a history of application of the recommendation settings.

8. The method of claim 7, wherein the applying of the weight to the at least one of the plurality of content groups comprises applying the weight to a content group corresponding to the recommendation settings, based on the recommendation settings applied to the electronic device.

9. The method of claim 7, wherein the applying of the weight to the at least one of the plurality of content groups comprises applying the weight to a content group having settings similar to settings applied to the electronic device, based on the recommendation setting not having been applied to the electronic device.

10. The method of claim 1, wherein the controlling of the outputting of the recommendation settings comprises controlling automatic application of the recommendation settings and outputting of information corresponding to a result of the application.

11. An electronic device for providing recommendation settings, the electronic device comprising:
a communication interface comprising communication circuitry;
at least one processor comprising processing circuitry; and
a memory storing instructions,
wherein at least one processor, individually and/or collectively, is configured to execute the instructions and to cause the electronic device to:
obtain a first usage pattern based on a usage score obtained from behavioral data over a first time period, corresponding to an interaction of a user with the electronic device,
obtain a second usage pattern, based on behavioral data over a second time period longer than the first time period, corresponding to an interaction of the user with the electronic device, and stored usage pattern data, and
control outputting of recommendation settings based on a time point of dissatisfaction with use of the electronic device, identified based on the first usage pattern and the second usage pattern.

12. The electronic device of claim 11, wherein
at least one processor, individually and/or collectively, is configured to cause the electronic device to:
obtain status information of the electronic device based on the time point of the dissatisfaction being identified, and
control outputting of, as the recommendation settings, settings associated with a content group corresponding to the status information from among a plurality of content groups,
wherein settings respectively associated with the plurality of content groups may be different from each other.

13. The electronic device of claim 12, wherein the settings respectively associated with the plurality of content groups are a plurality of settings stored, respectively corresponding to the plurality of content groups based on status information and grouped content information obtained from a plurality of devices.

14. The electronic device of claim 11, wherein
at least one processor, individually and/or collectively, is configured cause the electronic device to:
calculate the usage score based on usage frequencies of features included in the behavioral data over the first time period, and
identify a usage pattern as an abnormal usage pattern based on the usage score being greater than or equal to a first threshold.

15. The electronic device of claim 14, wherein
at least one processor, individually and/or collectively, is configured to cause the electronic device to:
identify, based on second thresholds respectively corresponding to the features of the behavioral data, features having usage frequencies greater than or equal to corresponding second thresholds, and
obtain a usage score for each time interval by applying weights respectively corresponding to the identified features,
wherein the second thresholds respectively corresponding to the usage frequencies of the features and the weights respectively corresponding to the features are different for each feature and are learnable.

16. The electronic device of claim 11, wherein at least one processor, individually and/or collectively is configured to cause the electronic device to identify an abnormal usage pattern via a usage pattern analysis model using the behavior data over the second time period as input data, wherein the usage pattern analysis model is trained based on a training dataset including the stored usage pattern data.

17. The electronic device of claim 12, wherein at least one processor, individually and/or collectively, is configured to cause the electronic device to apply a weight to at least one of the plurality of content groups based on history information indicating a history of application of the recommendation settings.

18. The electronic device of claim 17, wherein at least one processor, individually and/or collectively, is configured to cause the electronic device to apply the weight to a content group corresponding to the recommendation settings, based on the recommendation settings applied to the electronic device.

19. The electronic device of claim 17, wherein at least one processor, individually and/or collectively, is configured to cause the electronic device to apply the weight to a content group having settings similar to settings applied to the electronic device, based on the recommendation setting not having been applied to the electronic device.

20. A non-transitory computer-readable recording medium having recorded thereon a program which, when executed by at least one processor, comprising processing circuitry, individually and/or collectively, of a computer causes a device to perform the method of claim 1.
